(19) United States
(12) Patent Application Publication
(10) Pub. No.: US 2007/0256650 A1
(43) Pub. Date: Nov. 8, 2007

(54) Styled the system, asymmetric, engine/pump design

(76) Inventor: Stephen Antonius Ethelmer Pflughoeft, Glen Flora, WI (US)

Correspondence Address: STEPHEN ANTHONY ETHELMER PFLUGHOEFT, N-3468 HIGHWAY 73, GLEN FLORA, WI, 54526-9761, US

(21) Appl. No.: 11/429,529

(22) Filed: May 8, 2006

(51) Int. Cl. F02B 75/24; F02B 75/32

(52) U.S. Cl. 123/53.1; 123/197.4

(57) ABSTRACT

What is new in the art (or rather, technique) in the structuring of the linkage mechanism as it is most commonly used in the design of reciprocating piston heat/pressure engines and pumping/compressing machines are the two alterations and the combination thereof that I have invented. They are, #1, establishing a (very large) fixed and permanent offsetting, or asymmetry, between the geometric center axi of the cylinder and crankshaft for the purpose of altering the fundamentals of the working cycle, #2, the addition of a sub-link to the connecting rod such that it then also functions as an extension (alternately increasing and decreasing the working, or effective length) of the crankshaft arm during the rotation of the crankshaft, and #3, the combining of these two improvements as one unit, or in one machine.

### CROSS-REFERENCES TO RELATED (PATENT) APPLICATIONS

N/A

### STATEMENT REGARDING FEDERALLY SPONSORED RESEARCH AND/OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

The field of endeavor, or technical field, or field of invention to which this, my invention pertains is Mechanical Engineering, the sub-field (or sub-class) perhaps being Linkages, Mechanisms, Machines, and Structures.

Correctly speaking, this, my invention, is two improvements and their combination in the slider/crank type of the quadric-crank mechanism which is universally known of in the form of the reciprocating piston internal combustion engine.

A Listing of Definitions

Links, in mechanics, are nothing more or less than straight-line bars (refer also to VECTORS, in mathematics and mechanics).

Linkages, in mechanics, are combinations of such links, in general connected by pins, slides, rollers, or screws.

If the links can move relative to each other, the linkage then becomes a kinematic chain. Such linkages are usually referred to as mechanisms when the transmission of power, or energy, is not important.

If the combination is such that no relative motion can occur/exist between/among the parts, a structure exists.

MACHINES, however, involve the performance of work or the transmission of energy, or power, to some useful or desirable end.

Classification of Linkages

Basic to all linkages are the types of joints and/or pairs employed. Examples of such pairs are the pairs with geometrically similar areas in contact such as plain bearings, or a ball and socket joint, or a piston in a cylinder.

A further description is provided by the terms “turning pairs” (pin joints, sleeve bearings, etc.) and “sliding pairs” (gears, piston in cylinder, etc.).

One basic linkage is the four bar linkage of the Quadric-Crank Mechanism (see FIG. B-I 1). This consists of four links connected by pin joints with one link (I) generally static, or stationary. Link II is usually called a crank (crankshaft arm), link III a coupler (connecting rod), and link IV a lever.

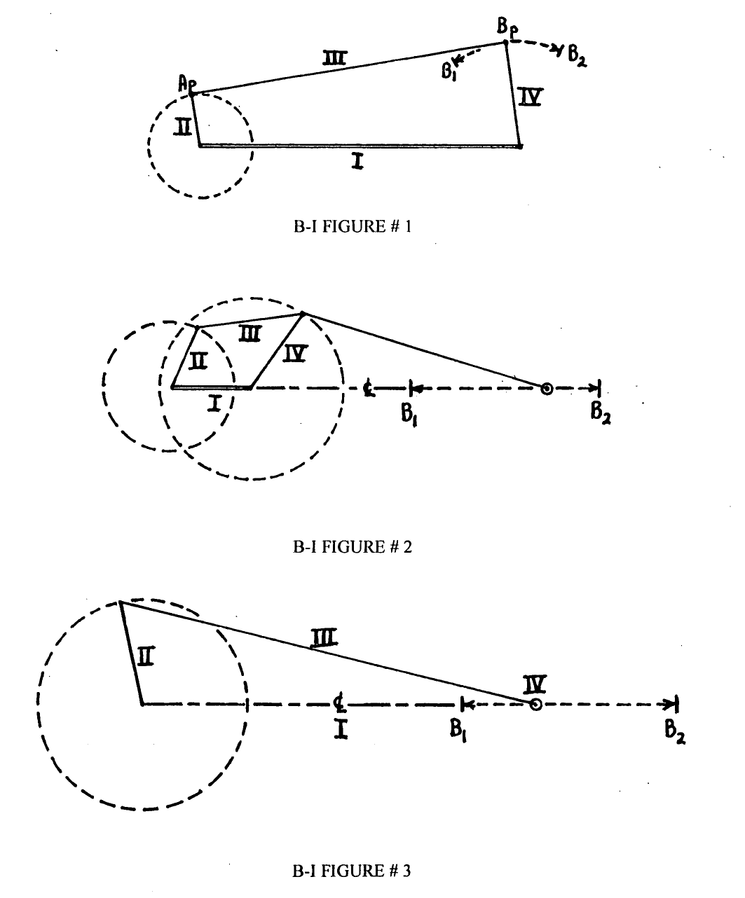

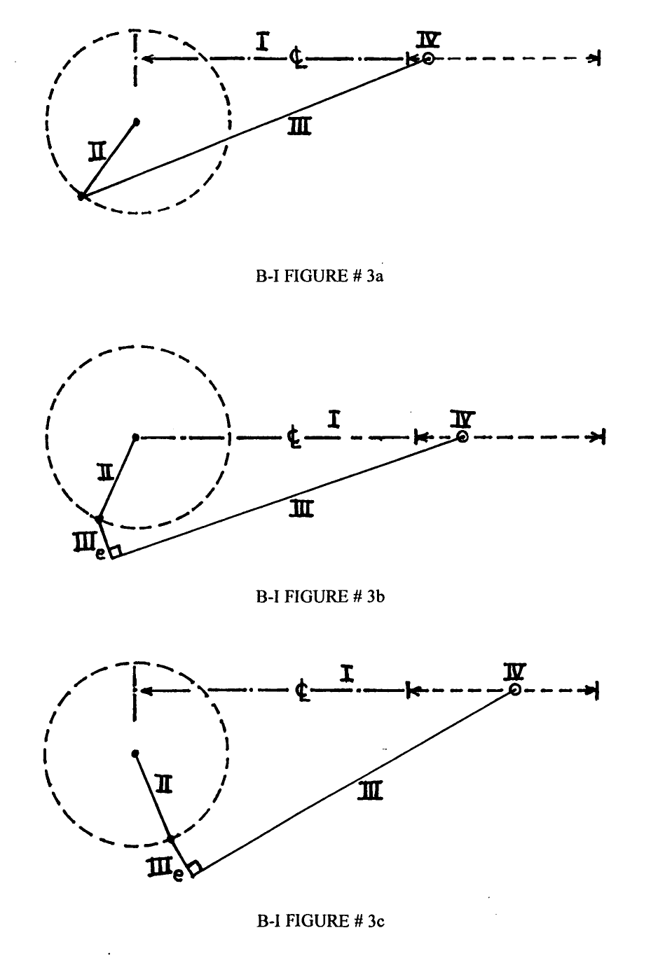

By varying the proportion of the links, different motions can be induced in link IV as well as along link III. In FIG. 1 the crank can make a complete rotation, or turn, around it's own axis while the lever oscillates between points B1 and B2 as shown of on the arc of the circle.

By altering the proportions, the drag-link mechanism may be created (see FIG. B-I 2). In this design, links II and IV both rotate completely, II (the driving linkage) at a constant speed and IV (the driven linkage) with variable speed.

A QUADRIC-CRANK LINKAGE IN WHICH THE “LEVER” MAY BECOME INFINITELY LONG IS REPRESENTED BY THE SLIDER/CRANK MECHANISM (see FIG. B-I 3). ONE OF THE PIN JOINTS HAS BEEN REPLACED BY THE RECTILINEAR (or cylindrolinear) SLIDING PAIR. IN THIS FORM IT IS THE FAMILIAR CRANKSHAFT-CONNECTING ROD-PISTON/CYLINDER ARRAY OF THE INTERNAL COMBUSTION ENGINE, AND GAS, VAPOR OR AIR COMPRESSOR, AND GAS, VAPOR OR FLUID PUMP.

This is shown in B-I, FIGS. 1 through 3 inclusive. I have, for the purposes of this application, found it necessary to define and include a new sub-classification of link—the link structure—as it is applied to devices such as heat/pressure engines and pumping/compressing machines.

This new class is nothing more than the combining of two (or more) links in a fixed (relative to each other) structure, with the intent of altering/modifying/changing the end result of work done, or energy transmitted, or motion produced as measured from one end of the kinematic chain to the other.

There may have been, in the past, such link structures made and used in mechanisms and machines of various kinds, types, or sorts, but to my knowledge—these have never been specifically defined and classified as such.

Most importantly, this kind, type, sort, or form of structure has obviously NEVER before been applied to use, or employment, in a heat/pressure engine or pumping/compressing machine of the slider/crank sub-type of QUADRIC-CRANK type mechanism. This is the basis of Claim #2 of this patent application.

The complex/compound term heat/pressure engine that I have used and will continue to use in this patent application refers to and encompasses any and all varieties of the slider/crank sub-types of the quadric-crank (or direct acting) mechanism that are employed and/or used as power/energy transmitting/transforming machines (also known of, called, defined, and referred to as engines). This particularly applies to the internal combustion engine, in terms of both physics and engineering as well as this patent application.

Correctly (and specifically) speaking, it is not heat that “runs” or “operates” such a machine (an internal combustion or other such engine), but a DIFFERENTIAL PRESSURE. Therefore, I have chosen to add the extra word to the term so that a clearer and more comprehensive understanding of the ACTUAL physics and mechanics involved may be obtained. However this differential pressure may be brought about, or caused, or induced is utterly irrelevant to this writing and has not been nor will be addressed here.

### Document References

The only specific documents that I have in my possesion and can refer to for the purpose of this patent application is a 1937 copy of Steam Power and Internal Combustion Enines, Auths. DUDLEY P. CRAIG & HERBERT J. ANDERSON, and a mid-1960s edition of the Encyclopedia Britannica with it's article bibliographies listed as follows:
ARTICLE: INTERNAL COMBUSTION ENGINE
P. M. HELDT
High Speed Combustion Engines (1946)
L. C. LICHTY
Internal-Combustion Engines (1951)
E. F. OBERT
Internal Combustion Engines (1950)
H. R. RICARDO
The High Speed Internal Combustion Engine (1953)
H. L. SOLBERG, O. C. CROMER, A. R. SPALDING
Elementary Heat Power (1952)
C. F. TAYLOR
Internal-Combustion Engine in Theory and Practice (1960)
ARTICLE: LINKAGES
V. L. DOUGHTIE, W. H. JAMES

Elements of Mechanism (1954)
J. S. BEGGS
Mechanism (1955)
C. W. HAM, E. J. CRANE, W. L. ROGERS
Mechanics of Machinery (1958)
V. M. FAIRES
Kinematics (1959)
ARTICLE: STEAM
W. N. BARNARD, F. O. ELLENWOOD
Heat Power Engineering/i, ii, iii (1935)
W. H. SEVERNS, H. E. DEGLER, J. C. MILES
Steam, Air, and Gas Power-5^{th} Edition (1954)

The article LINKAGES is the most important in the technical sense as applied here; it contains a, or the, listing of definitions which clearly define the structures of my invention and their functional interrelationships.

This listing of definitions is, in fact, central as far as precisely and specifically establishing the novelty of my invention and it's technical supremacy over the now obsolete symmetrical type engine/pump designs.

Other information such as is known to me has been accumulated from an undefinable and indiscriminate variety of sources, but two potentially relevant facts with a seeming effect on the specifics of one of the structural alterations/improvements that constitute my invention must be addressed.

The first of these facts is the statement (not independently or separately verified) by a distant but extra-ordinarily knowledgeable and extremely reliable acquaintance that some automobile, or automotive type engines are being or have been, in the past, manufactured/constructed/built with such an inherent or integral asymmetry as part of their design similar to what I have invented as a part (Claim #1) of this, my invention.

However, the amount/proportion of the offset, or asymmetry, is small in comparison to the amount that I have calculated as necessary to be effective for the intended purpose and propose to employ in my invention.

Most of all, and of absolute importance as relates to this patent application is that such asymmetry, or offset, as these other machines may have is solely and exclusively intended, designed, and built in to moderate/dampen/reduce/eliminate harmonic vibration buildup in the motion works as a result of torsional elastic distortion over the length of the crankshaft with the associated, related, and resulting destructive effects thereof. This older or prior design is therefore irrelevant to this application.

The second of these two facts concerns a design, by SAAB or Volvo, of an engine that may seem, in part, to have some relevance here, but even the most cursory examination will show that it will have no bearing on this application.

This machine, as designed, consists of a cylinder block/structure made as a separate part and distinct from the crankshaft case/block/structure. These two (sub) structures are connected by a pin, or shaft, or trunnion at one side and parallel to the crankshaft which allows them to pivot or move with respect to each other, even while in operation. This motion, or changing of position with respect to each other is, however, solely and exclusively for the purpose of altering/varying the compression ratio. The asymmetry that results from the pivoting motion of the two parts is an irrelevant side effect

Equally so, the nature of these improvements is in NO way related to or akin to such a design as the original “Diesel” engine with it's geared offset cylinder/axleshaft mechanism as part of a “free” piston design (slider/slider PAIRS), or the various multiple connecting link mechanism/machine arrays (Atkinson, Snyder, Dolbert, etc.) that were employed in heat/pressure (internal combustion) engines as patent evading design techniques.

### A BRIEF SUMMARY OF THE INVENTION

The substance of this, my invention, THE STRUCTURE, ASYMMETRIC, ENGINE/DESIGN, is to separately alter, as improvements, two parts of the slider/crank type of quadric-crank mechanism, thereby creating two nominally new mechanisms, and then to combine the two improvements in/as a third and definitely new mechanism.

There are two specific and separate changes and the one combination thereof that constitute the base and sum of this, my invention.

The first of these changes (Claim #1) is to offset the “slider” part (the slider/bearing pair) of the slider/crank mechanism with the sole and exclusive intent and purpose of fundamentally and permanently changing the vectors, angles, forces and duration of the working cycle of any such machine so built.

This, the first (Claim #1) improvement, can, in and of and by itself, materially increase the discreet energy efficiency/fuel economy as applied to use in heat/pressure engines so designed and built.

The second of these changes (Claim #2) is to alter/modify/change the connecting link of the slider/crank mechanism by, or with, the addition of a sub-link at a nominal right angle to the length of the first, or primary link at the crankshaft end of the link.

This extra/additional sub-link will alternately increase and decrease the effective/functional working length of the crank (crankshaft arm) as this part rotates, with the sole specific intent of fundamentally altering/changing the vectors and forces transmitted during the working cycles.

This, the second (Claim #2) improvement can, in and of and by itself, greatly increase the discreet energy efficiency/fuel economy as it is applied to use in heat/pressure engines, and considerably so as it is applied to use in pumping/compressing machines, and materially so as it is applied to use in material forming/cutting machines (machine tools).

Combining these two changes (improvements) in a single mechanism constitutes the third claim (Claim #3) of this utility patent application. The effect of the combination of the two improvements, it must be noted, is to MULTIPLY the effects of the improvements by each other's proportional factors.

The advantages of my invention are twofold. The first being to greatly increase the net work output per specific energy input as compared to the older, considerably less efficient and now obsolete symmetric design type engines, pumps, and machine tools. The second of the advantages is, with engines, that the size, weight, and cost can be greatly reduced per net specific output.

### A BRIEF DESCRIPTION OF THE SEVERAL DRAWINGS

### B-I Drawings-Showing Linkage Mechanisms

FIG. 1-A four bar linkage of the rotating/oscillating type, wherein link I (the base) is stationary, link II is usually called a crank, link III a coupler, and link IV a lever. In this figure the crank rotates completely around it's axis at point A while the lever oscillates as shown by the dotted line.

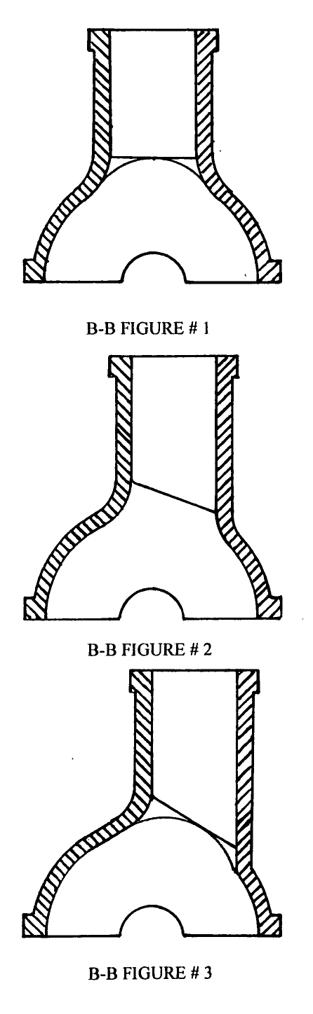

FIG. 2-A four bar linkage of a rotating/rotating type wherein link II (the driving link, or driver) rotates at a constant speed and link IV at varying speeds. This is usually called a drag link mechanism.

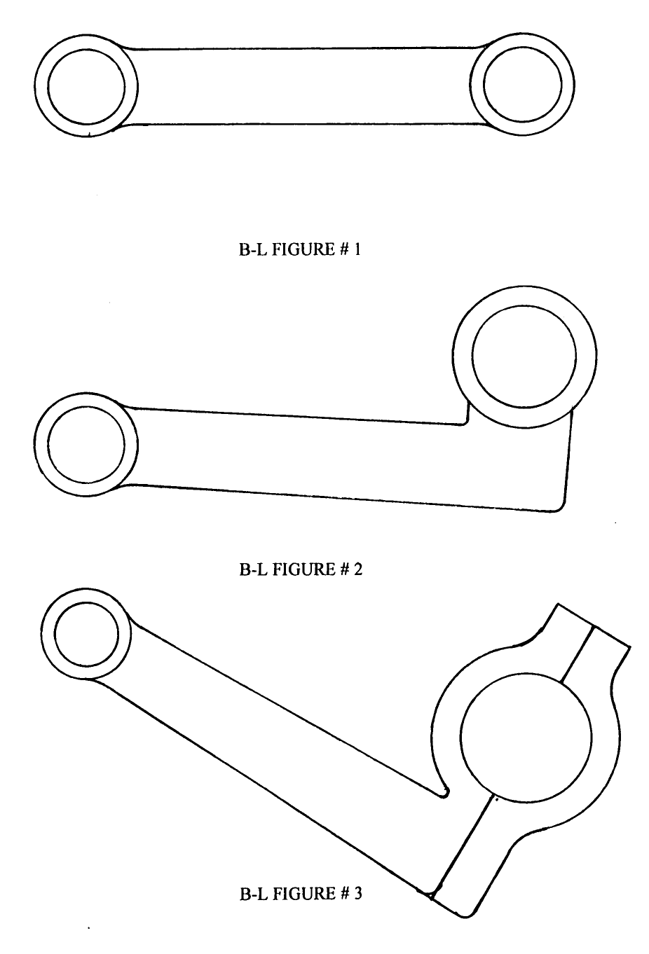

FIG. 3-A four bar linkage of the rotating/sliding type. This is the slider/crank mechanism of engine/pump reknown.

FIG. 3a-The offset axi sub-type of the rotating/sliding type.

FIG. 3b-The asymmetric link (structure) sub-type of the rotating/sliding type.

FIG. 3c-The combined offset axi/asymmetric link (or double asymmetric) sub-type of the rotating/sliding type.

### B-B Drawings-Showing Block Structures. All Drawings are Front Sectional Views

FIG. 1-An everyday symmetric engine/pump block structure. The line of the geometric center axis of the cylinder bore (which is almost invariably circular) intersects the center axis of the crankshaft.

FIG. 2-A “half” offset asymmetric block structure. The line of the geometric center axis of the cylinder bore intersects the circle described by the crankshaft's rotation one half radius' distance from the center axis.

FIG. 3-A “full” offset asymmetric block structure. The line of the geometric center axis of the cylinder bore is tangent to the circle described by the crankshaft's rotation.

### B-L Drawings—Showing Link Types and Structure. All Drawings are Front Views

FIG. 1-A simple link, or bar, of the most basic type. Any force, or effort, exerted along its length through the connecting pin joint at one end will be directly and linearly transferred through the connecting pin joint at the other end. NOTE—As long as the force exerted is directly and linearly transferred from one joint to the other through the physical mass structure of the link, the link is considered to be simple. The vector of the force, or pressure, or effort is measured from the centerpoint of the one connecting member (pin, etc.) to the other.

FIG. 2-The ASYMMETRIC LINK STRUCTURE WITH AN INDIRECT VECTOR. The first characteristic is that the vector is indirect, with the consequent effect on the forces transmitted through/along/by the structure. The second characteristic is that the “legs” are unequal in their proportions; as a result, any force or effort exerted on one end will be altered in magnitude and vector depending on the proportions of the various lengths and angles whose factors are multiplied by and against each other in accordance with the laws of mathematics and physics.

FIG. 3-This is an example of what a typical engine connecting rod, or piston rod may look like.

### B-M Drawings—Showing Mechanisms. All Drawings are Front Sectional Views

FIG. 1-An ordinary, everyday, obsolete symmetric type engine/pump mechanism.

FIG. 2-An asymmetric block (1) with a symmetric connecting rod or link (2).

FIG. 3-A symmetric block (1) with an asymmetric connecting rod, or link (2).

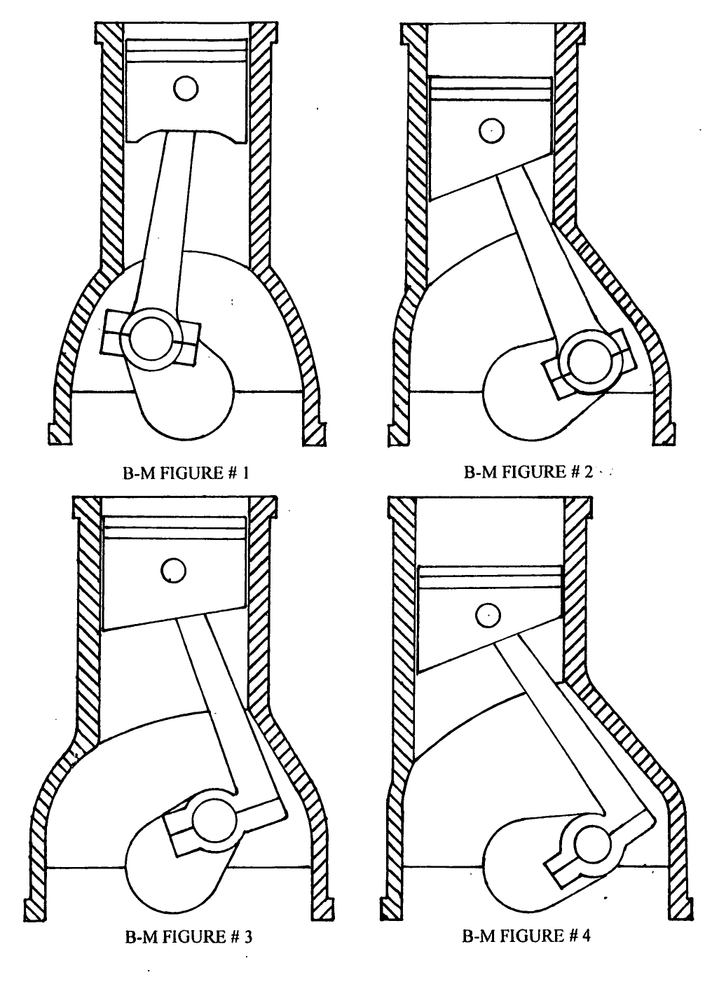

FIG. 4-An asymmetric block (1) with an asymmetric connecting rod, or link (2).

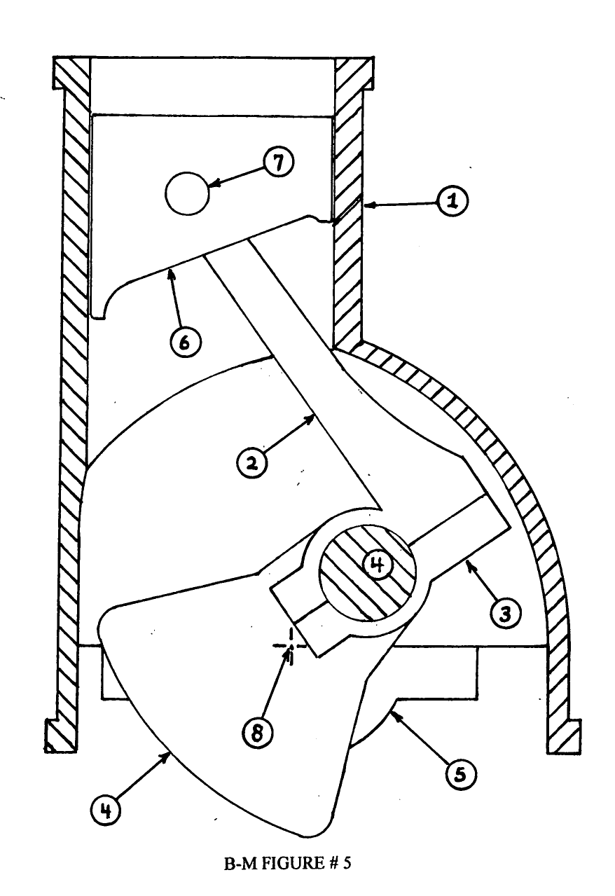

FIG. 5 (Separate Page)-A larger scale drawing of a complete (Claim #3) double asymmetric mechanism, or Structure, Asymmetric, Engine/Pump Design. The parts are numbered as follows:

Part #1 is the cylinder (engine) block.

Part #2 is the (piston) connecting rod, or link.

Part #3 is the (piston) connecting rod, or link bearing (end) cap.

Part #4 is the crankshaft.

Part #5 is the crankshaft (main) bearing cap.

Part #6 is the piston.

Part #7 is the piston pin.

“Part”# 8 is the central rotating axis of the crankshaft

This (B-M FIG. 5) is the suggested drawing for publication.

### DETAILED DESCRIPTION OF THE INVENTION

What is Old

With the slider/crank type of the quadric-crank mechanism—a line described along/through the nominal geometric center axis of the line of travel of the slider/bearing portion or part of the mechanism and extended through the area of the center (central rotating) axis of the crank (crankshaft) will (almost) invariably intersect the (line of the) geometric center (or central rotating) axis of the crankshaft (B-I FIG. 3).

Since this line of the slider/bearing travel axis effectively bisects the physical structure of the mechanism (machine) into two equal or mirror image parts, this old and now obsolete design will be called or referred to as the symmetric mechanism, or symmetric structure, or symmetric pattern, etc.

The very few (if any) heat/pressure engines that diverge from this classic pattern do so solely and exclusively in order to moderate/dampen/reduce/eliminate harmonic vibrational buildup in the motion works and the damaging and destructive effects thereof

I have absolutely no knowledge whatsoever of any pumping/compressing machines that vary or diverge from this pattern of symmetry.

Certain material forming/cutting machines (machine tools) use a variant form of the asymmetric “block” sub-type of this mechanism in the form of the Whitworth Quick Return Mechanism WITH, however, an additional slider/slider pair (gears) and extra eccentric links.

With the slider/crank type of quadric-crank mechanism—a line described through the center of the connecting pin joint (axis) at one end of the connecting link (connecting link, or connecting rod) through the center of the connecting pin joint (axis) at the other end will pass through (remaining inside) the physical structure of the connecting link (B-L FIG. 1).

Since this line through the connecting pin joint axi almost invariably equally bisects the physical structure of such a link into two identical halves, this old and now obsolescent design will be called or referred to as the symmetric link, or symmetric connecting rod.

No heat/pressure engines diverge from this pattern.

No pumping/compressing machines diverge from this pattern

To my limited knowledge, no machine tools diverge from this pattern.

Explanation of the Invention

This, my invention, THE STRUCTURE, ASYMMETRIC, ENGINE/PUMP DESIGN, consists of, or comprises, two improvements and one combination thereof (Claims #1, #2, and #3, respectively).

The first part of my invention (Claim #1) is an improvement of the slider/crank type (B-I FIG. 3) of the quadric-crank mechanism (B-I FIGS. 1, 2, 3).

This improvement consists of displacing, or offsetting the slider (slider/bearing) part of the mechanism (IV of B-I FIG. 3) with respect to the crank (crankshaft) part of the mechanism (II of B-I FIG. 3) such that the geometric center axi of the two do not and cannot coincide, or intersect.

This is schematically represented in B-I FIGS. 3a and 3c.

This is done solely and exclusively with the intent and for the purpose of fundamentally altering/changing the vectors, angles, forces, and duration of the working cycles of such machines with the objective of increasing the specific (power) output and/or fuel economy/energy efficiency of such machines so designed and built (B-B FIGS. 2, 3 and B-M FIGS. 2, 4).

By mathematical modeling and analysis of the various cycles of such a machine design, the amount or proportion of such an offset, or asymmetry will be very large.

For a heat/pressure (internal combustion) engine the working range for such a “single asymmetric” (block only) machine will range approximately between one-half and two-thirds of the radius of the crankshaft “throw” (the circle described by the rotation of the crankshaft arm, as measured from the center axis of the crankshaft to the center axis of the connecting link bearing on the crankshaft arm).

This structure, which functions as link I in B-I FIGS. 1, 2, 3, is commonly referred to as an engine block (as applied to use in engines) or a pump/compressor piston block (as applied to use in these other such machines). This structure (in mechanisms, actually a link) may be made as two or more sub-structures.

The second part of my invention (Claim #2) is an alteration/improvement of the slider/crank sub-type (B-I FIG. 3) of the quadric-crank mechanism (B-I FIGS. 1, 2, 3) as it is used/employed in the design of reciprocating piston heat/pressure engines and pumping/compressing machines.

This improvement consists of the converting/altering/changing the simple, direct vector connecting link of the mechanism (III of B-I FIG. 3 and B-L FIG. 1) into a compound, indirect vector, connecting link structure (IIIe of B-I FIGS. 3b and 3c) by the addition of a sub-link (proportionately, a stub-link) at a nominal right angle to the length of the original/primary link at the end of the link that is connected to the crank (crankshaft arm).

This is schematically represented in B-I FIGS. 3b and 3c, and graphically in B-L FIGS. 2 and 3.

This is done solely and exclusively with the intent and for the purpose of altering/changing the vectors, angles, forces of the working cycles of such machines so designed and built (B-L FIGS. 2, 3 and B-M FIGS. 3, 4).

By mathematical modeling and analysis of the characteristics of the working and other cycles of a machine so designed—the proportionals of the relative lengths and angles must stay within strictly defined and decidedly narrow limits.

This link structure, or linkage, which functions as link IIIe in B-I FIGS. 3b and 3c, is commonly known of and referred to as a connecting rod or a piston rod. Either term is acceptable and they are used interchangeably. The terms are also identical as used with reference to heat/pressure engines and pumping/compressing machines (B-M FIGS. 3 and 4). Material forming/cutting tools (machine tools) may use/have different descriptive terms.

The third part of this, my invention (Claim #3), is the combining of the two structural/mechanical changes in one entirely new mechanism, as it is applied to use in any and all machines including (but not limited to) such machines as heat/pressure engines, pumping/compressing machines, and machine tools.

This is schematically shown in B-I FIG. 3c and descriptively in B-M FIG. 4.

By mathematical analysis of the additional various and variable factors involved (as applied to internal combustion engines) I will state that a nominal 50% increase of discreet fuel economy/energy efficiency is readily achievable in such an (it's primary) application, with pumping/compressing machines demonstrating perhaps somewhat less improvement.

What I claim as my invention is as follows: Two alterations (improvements) of the slider/crank type of the quadric-crank mechanism and the combination of the two said alterations (improvements) together in one operating mechanism or machine:

1. is an improvement consisting of the “offsetting” of (or construction of the “block” structure such that) the slider part and the crank part of the slider/crank type of the quadric-crank mechanism so that the line of travel, or projected/extended line of travel of the nominal geometric center axis of the slider does not and cannot coincide with or intersect the center (or central rotating) axis of the crank (crankshaft).
I claim patent protection for this sub-type of slider/crank type of quadric-crank mechanism as it employed/used in the design and/or manufacture of heat/pressure engines and pumping/compressing machines for the purpose of effecting an increase in the discreet fuel economy/energy efficiency of such machines by changing the dynamics and duration of the working cycles of such machines so designed and built.

2. is an improvement consisting of the addition of a sub-link (proportionately a stub link) to the original straight simple connecting link at a nominal right angle to the length of the original or primary link (thereby creating a link structure, or linkage) at the end of the link that is connected to the crank (crankshaft arm).
I claim patent protection for the design, manufacture, construction, use or employment of this type or subtype of connecting link as it may be used in any kind, type, sub-type or sort of quadric-crank mechanism or machine or any other kind, type, sub-type or sort of mechanism or machine with particular emphasis on it's application to or use in the design, manufacture, construction and/or use in heat/pressure engines of any kind, type, sub-type, or sort for any purpose or reason of any kind, pumping/compressing machines of any kind, type, sub-type or sort for any purpose or reason of any kind, and machine tools of any kind, type, sub-type or sort for any purpose or reason of any kind.

3. is the combining of these two improvements (claim #1 and claim #2) in one entirely new sub-type of the slider/crank type of quadric-crank mechanism. While the two previous evolutions of this mechanism may be (separately) defined as asymmetric, I will define this entirely new sub-type as the double asymmetric. In this application, claim #3 is dependent on the combination of claim #1 and claim #2 in one mechanism (machine).
I claim patent protection for this entirely new type or sub-type of mechanism as it may be used in any way, form, or fashion in the design, manufacture, construction, or use of/in any mechanism or machine of any kind, type, sub-type or sort for any reason of any kind whatsoever.
Note-While the two separate improvements are not absolutely dependent on each other (they may very well be used separately), good engineering practice and mechanical design factors (compactness in construction, thermodynamic efficiency, fuel economy, etc.) indicate that they be combined when used/employed in the design/construction of mechanisms and machines.
